(19) United States
(12) Patent Application Publication
(10) Pub. No.: US 2011/0119109 A1
(43) Pub. Date: May 19, 2011

(54) HEADCOUNT FORECASTING SYSTEM

(75) Inventors: Benjamin T. Teal, Charlotte, NC (US); Dan Yang, Charlotte, NC (US); Timothy J. Prentice, Charlotte, NC (US); Unnikrishnan P. Vasudevannair, Charlotte, NC (US)

(73) Assignee: BANK OF AMERICA CORPORATION, Charlotte, NC (US)

(21) Appl. No.: 12/618,017

(22) Filed: Nov. 13, 2009

(51) Int. Cl. G06Q 10/00; G06F 17/30; G06N 5/02

(52) U.S. Cl. 705/7.31; 706/52; 707/E17.044; 707/E17.014; 705/7.22

(57) ABSTRACT

Embodiments of the present invention provide systems, apparatuses, methods, and computer program products for forecasting the future headcount of an organization by generating, validating and displaying models of the headcount of an organization or division thereof over time. In some embodiments, at least three different models are generated using stored historical headcount information, including a linear regression model, a multivariate model using macroeconomic variables, and an autoregressive moving average model. In some embodiments, for each of the foregoing types, multiple models are generated and the best model of each type is selected for use in forecasting headcount according to predetermined evaluation criteria.

### FIELD

In general, the invention relates to systems, apparatuses, methods, and computer program products for forecasting the future headcount of an organization. More particularly, embodiments of the invention provide systems, apparatuses, methods, and computer program products configured to generate, validate and display multiple different models of the headcount of an organization or division thereof over time.

### BACKGROUND

In order to effectively plan future operations of an organization, including the organization's budget, real estate needs, etc., an accurate estimation of the organization's headcount in the future is often needed. Indeed, there may be many different headcounts that planners wish to forecast, including total number of employees of the organization, total number of employees and contractors, total number of employees within a particular division of the organization etc. Current methods of generating headcount forecasts involve the time-consuming process of generating a historical account of the headcount over time as well as any considerations that may affect the headcount going forward. This process often involves coordinating with different business groups within the organization, including human resources, corporate real estate planners, and statistical solution experts. While this may be a workable forecasting solution for a small organization that is well-equipped to readily know exactly what its headcount has been and what it is likely to be in the future, complex organizations often struggle to generate accurate headcount forecasts that corporate planners may rely upon in a timely manner. It is often difficult to obtain the necessary information to render a model, and consequently it may take weeks or months to provide the planners with a forecast they can use. Additional delay may be caused if the planners wish to consider multiple different models. Furthermore, current methods of predicting headcount do not address the likelihood of error of the forecast, which is an important component for planners to consider.

Accordingly, there is a need for systems, devices, methods, and other tools that allow a corporation to obtain multiple comprehensive automated models of the headcount of a particular organization or division thereof in real-time.

### BRIEF SUMMARY

Embodiments of the present invention provide a system for forecasting the future headcount of a group of individuals comprising a user interface, a memory device comprising computer-readable program code, historical headcount data for the group and macroeconomic data, and a processor operatively coupled to the user interface and the memory device and configured to execute the computer-readable program code to receive, via the user interface, a request for a forecast of the future headcount of the group of individuals, locate in the memory device, in response to the request, the historical headcount data for the group and the macroeconomic data, utilize the historical headcount data to generate at least one linear regression model and at least one autoregressive moving average model, utilize the historical headcount data and the macroeconomic data to generate at least one multivariate macroeconomic model, and display one of the at least one linear regression models, one of the at least one autoregressive moving average models, and one of the at least one multivariate macroeconomic models via the user interface.

In some embodiments, the processor is configured to display one of the at least one linear regression models, one of the at least one autoregressive moving average models, and one of the at least one multivariate macroeconomic models in combination on a graph having time on the x-axis and headcount on the y-axis. In one embodiment, the system also has a network interface, and the processor is configured to further execute the computer-readable program code to obtain at least a portion of the historical headcount data via the network interface from a database comprising information about the individuals. According to one embodiment, the processor is configured to further execute the computer-readable program code to obtain at least a portion of the macroeconomic data via the network interface from an online service provider.

In some embodiments, the historical headcount data comprises a time series of the headcount of the group over a period of time prior to utilization of the system. In some embodiments, the macroeconomic data comprises historical and forecasted values for a plurality of macroeconomic variables. In such embodiments, the processor may be configured to further execute the computer-readable program code to generate at least one time-lagged variable for each macroeconomic variable in the plurality of macroeconomic variables. Indeed, the processor may be configured to further execute the computer-readable program code to perform a stepwise analysis using the historical headcount data and the macroeconomic data to determine which of the plurality of macroeconomic variables and the time-lagged variables are correlated with the historical headcount data. In such embodiments, the at least one macroeconomic model may be generated using the macroeconomic variables and time-lagged variables that are correlated with the historical headcount data.

In some embodiments of the system, the processor is further configured to execute the computer-readable program code to smooth the historical headcount data. In one embodiment, the processor is further configured to execute the computer-readable program code to receive, via the user interface, a selection of minimum R-squared value and confidence level. According to one embodiment, the processor is further configured to execute the computer-readable program code to receive, via the user interface, a selection of bubble size. In some embodiments, the system is configured to only display models that meet a minimum R-squared and have normally-distributed residuals. In some embodiments, the system is configured to forecast the future headcount of more than one group of individuals.

According to some embodiments, the historical headcount data comprises headcount time series related to multiple groups, and each headcount time series is stored in connection with an identifier associated with the group of individuals to which the headcount time series relates. In such embodiments, the headcount time series may be located in the memory device in response to a request by utilizing the identifier.

In some embodiments of the system, the processor is further configured to execute the computer-readable program code to disqualify for display any model rendered by the system that does not have an R-squared value that meets or exceeds a predefined minimum, and disqualify for display any model rendered by the system that does not have normally-distributed residuals. In such embodiments, the processor is further configured to execute the computer-readable program code to select the one linear regression model for display from any linear regression models not previously disqualified based on the number of data points in the time series used to render it, select the one multivariate macroeconomic model for display from any multivariate macroeconomic models not previously disqualified based on the number of data points in the time series used to render it, and select the one autoregressive moving average model for display from any autoregressive moving average models not previously disqualified based on an Akaike information criterion analysis.

Embodiments of the present invention also provide a method for forecasting the future headcount of a group of individuals comprising: (1) storing historical headcount data for the group of individuals; (2) identifying macroeconomic variables that are correlated to the historical headcount data; (3) storing historical and forecasted macroeconomic data for the identified macroeconomic variables; (4) generating at least one linear regression model and at least one autoregressive moving average model utilizing the stored historical headcount data; (5) generating at least one multivariate macroeconomic model utilizing the stored historical headcount data and the stored macroeconomic data; and (6) presenting one of the at least one linear regression models, one of the at least one autoregressive moving average models, and one of the at least one multivariate macroeconomic models in combination.

In some embodiments, at least a portion of the historical headcount data was obtained via a network from a database comprising human resources information relating to the individuals. In some embodiments, at least a portion of the macroeconomic data was obtained via a network from an online service provider. According to some embodiments, the historical headcount data comprises one or more headcount time series. In some embodiments, the macroeconomic variables are identified utilizing a stepwise analysis process. According to some embodiments, the macroeconomic variables comprise time-lagged variables. Some embodiments of the method may also include receiving a request from a user for a headcount forecast, receiving a selection of minimum R-squared value and confidence level, and/or smoothing the historical headcount data to remove any outliers.

In some embodiments of the method of the present invention, a plurality of linear regression models are generated, a plurality of multivariate macroeconomic models are generated, and a plurality of autoregressive moving average models are generated. In some embodiments, each linear regression model in the plurality of linear regression models was generated using a different portion of the historical headcount data, each multivariate macroeconomic model in the plurality of multivariate macroeconomic models was generated using a different portion of the historical headcount data, and each autoregressive moving average model in the plurality of autoregressive moving average models has either a different autoregressive order or a different moving average order. The method may further comprise disqualifing for display any model generated that does not have an R-squared value that meets or exceeds predefined minimum, and disqualifing for display any model generated that does not have normally-distributed residuals. In some embodiments, the one linear regression model displayed is selected from any linear regression models not previously disqualified based on the length of the time series used to render it, the one multivariate macroeconomic model displayed is selected from any multivariate macroeconomic models not previously disqualified based on the length of the time series used to render it, and the one autoregressive moving average model displayed is selected from any autoregressive moving average models not previously disqualified based on an Akaike information criterion analysis

Embodiments of the present invention also provide a computer program product for forecasting the future headcount of a group of individuals comprising a computer-readable medium having computer-readable program code stored therein, wherein the computer-readable program code comprises: a first code portion configured to obtain via a first network historical headcount data for the group of individuals; a second code portion configured to identify macroeconomic variables that are correlated to the historical headcount data; a third code portion configured to obtain historical and forecasted macroeconomic data corresponding to the identified macroeconomic variables; a fourth code portion configured to generate at least one linear regression model and at least one autoregressive moving average model utilizing the stored historical headcount data; and a fifth code portion configured to generate at least one multivariate macroeconomic model utilizing the historical headcount data and the macroeconomic data. In some embodiments, the computer program product further comprises a sixth code portion configured to display via a user interface one of the at least one linear regression models, one of the at least one autoregressive moving average models, and one of the at least one multivariate macroeconomic models in combination.

According to some embodiments, the computer program product further comprises: a seventh code portion configured to receive a time value via a user interface; an eighth code portion configured to input the time value into the at least one linear regression model, the at least one autoregressive moving average model, and the at least one multivariate macroeconomic model to calculate three headcount values corresponding to the time value; and a ninth code portion configured to display the three headcount values via the user interface.

### BRIEF DESCRIPTION OF THE DRAWINGS

Reference will now be made to the accompanying drawings to describe some embodiments of the invention, wherein:

FIG. 1 provides a block diagram of a headcount forecasting environment, in accordance with one embodiment of the present invention;

FIG. 2 provides a flow diagram illustrating a process whereby the headcount forecasting system of the present invention obtains, generates, stores and manages headcount data and macroeconomics data, in accordance with an embodiment of the present invention;

FIG. 3 provides a chart displaying the thirty-six different macroeconomic variables that may be used by the macroeconomic model of the present invention, according to one embodiment of the invention;

FIG. 4 provides a flow chart that illustrates a process whereby the headcount forecasting system of the present invention generates three unique models of the headcount of a particular organization or division thereof over time, including an inferential statistics model, a macroeconomic model, and an autoregressive moving average (“ARMA”) model, and displays such models to a user via the user interface, in accordance with one embodiment of the present invention; and

FIGS. 5A, 5B, 5C, and 5D provide a number of outputs of the headcount forecasting system of the present invention, as displayed to a user via a user interface, in accordance with one embodiment of the present invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of ordinary skill in the art in view of this disclosure, the present invention may be embodied as a method, system, apparatus, computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-readable medium having computer-usable program code embodied in the medium.

Any suitable computer-readable medium may be utilized, including a computer-readable storage medium and/or a computer-readable signal medium. The computer-readable storage medium may be, for example but not limited to, an electronic, magnetic, optical, electromagnetic, infrared, or semiconductor storage system, apparatus, or device. More specific examples of the computer-readable storage medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. A computer-readable signal medium may include a propagated data signal with computer program instructions embodied therein, for example, in base band or as part of a carrier wave. Such a propagated signal may take any of a variety of forms, including, but not limited to, electro-magnetic, optical, or any suitable combination thereof. In the context of this document, a computer-readable medium may be any medium that can contain, store, communicate, and/or transport the program for use by or in connection with the instruction execution system, apparatus, or device.

Computer program code for carrying out operations of embodiments of the present invention may be written in an object-oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It will be understood that each block of the flowchart illustrations, and/or combinations of blocks in the flowchart illustrations, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture, including instruction means which implement the function/act specified in the flowchart block(s).

The computer program instructions may also be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the functions/acts specified in the flowchart block(s). Alternatively, computer program implemented steps or acts may be combined with operator or human implemented steps or acts in order to carry out an embodiment of the invention.

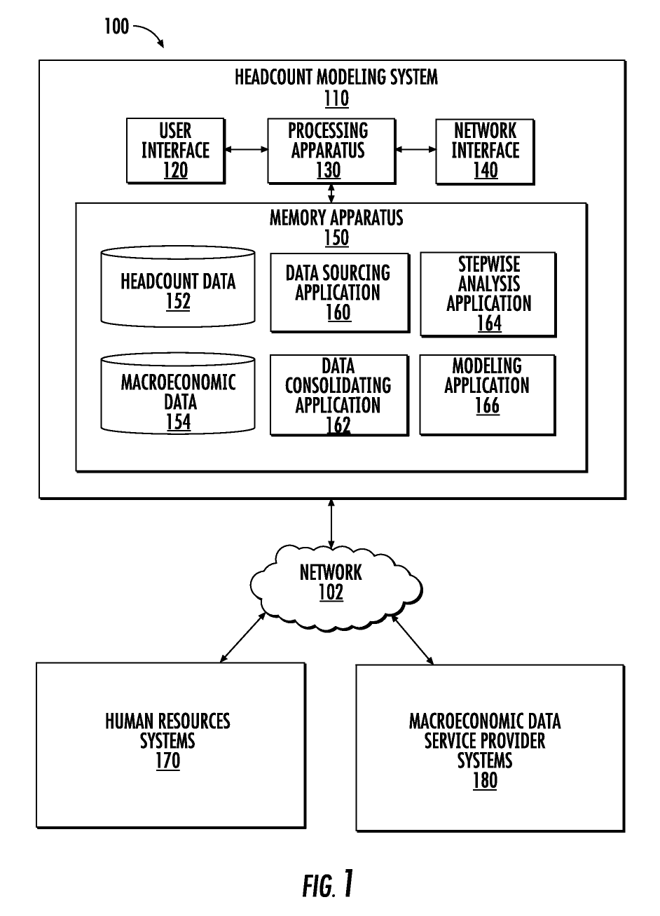

FIG. 1 provides a block diagram of a headcount forecasting environment 100, in accordance with one embodiment of the present invention. The headcount forecasting environment 100 generally includes a headcount forecasting system 110 in communication with the human resources computer systems 170 of a subject organization and one or more macroeconomic data service provider computer systems 180 via a network 102. The headcount forecasting system 110 comprises a user interface apparatus 120, a network interface apparatus 140, and a memory apparatus 150 operatively coupled to a processing apparatus 130. As described in greater detail below, embodiments of the headcount forecasting system 110 are generally configured to generate, validate, and display in combination three different headcount models for an organization or particular division or portion thereof. In this regard, in some embodiments of the invention, the headcount forecasting system 110 is owned or maintained by such organization, and the headcount forecasting system 110 may, in some embodiments, be integrated with other systems of such organization and may share at least some hardware, software, and/or other resources with such other systems. In other embodiments, the headcount forecasting system 110 may be owned and/or operated by a service provider engaged by the organization to provide headcount forecasting services or another third party that is interested in forecasting the headcount of the organization or a division thereof.

As used herein, the term apparatus refers to a device or a combination of devices having the hardware and/or software configured to perform one or more specified functions. Therefore, an apparatus is not necessarily a single device and may, instead, include a plurality of devices that make up the apparatus. The plurality of devices may be directly coupled to one another or may be remote from one another, such as distributed over a network.

It should be understood by one of ordinary skill in the art in view of this disclosure that, although FIG. 1 illustrates the user interface 120, network interface 140, memory apparatus 150, and processing apparatus 130 as separate blocks in the block diagram, these separations may be merely conceptual. In other words, in some instances, the user interface 120, for example, is a separate and distinct device from the processing apparatus 130 and the memory apparatus 150 and therefore may have its own processor, memory, and software. In other instances, however, the user interface 120 is directly coupled to or integral with at least one part of the processing apparatus 130 and at least one part of the memory apparatus 150 and includes the user interface input and output hardware used by the processing apparatus 130 when the processing apparatus 130 executes user input and output software stored in the memory apparatus 150.

As will be described in greater detail below, in one embodiment, the headcount forecasting system 110 is entirely contained within a user terminal, such as a personal computer or mobile terminal, while, in other embodiments, the headcount forecasting system 110 includes a central computing system, one or more network servers, and one or more user terminals in communication with the central computing system via a network and the one or more network servers. FIG. 1 is intended to cover both types of configurations as well as other configurations that will be apparent to one of ordinary skill in the art in view of this disclosure.

The user interface 120 includes hardware and/or software for receiving input into the headcount forecasting system 110 from a user and hardware and/or software for communicating output from the headcount forecasting system 110 to a user. In some embodiments, the user interface 120 includes one or more user input devices, such as a keyboard, keypad, mouse, microphone, touch screen, touch pad, controller, and/or the like. In some embodiments, the user interface 120 includes one or more user output devices, such as a display (e.g., a monitor, liquid crystal display, one or more light emitting diodes, etc.), a speaker, a tactile output device, a printer, and/or other sensory devices that can be used to communicate information to a person. In one embodiment, the user interface 120 includes a user terminal, which terminal may be used by an individual tasked with utilizing the headcount forecasting system 110 to generate headcount models and obtain forecasts regarding headcount for a particular organization or division thereof.

In some embodiments, the network interface 140 is configured to receive electronic input from other devices in the network 102, including the human resources computer systems 170 of a subject organization and the macroeconomic data service provider computer systems 180. In some embodiments, the network interface 140 is further configured to send electronic output to other devices in a network. The network 102 may include a direct connection between a plurality of devices, a global area network such as the Internet, a wide area network such as an intranet, a local area network, a wireline network, a wireless network, a virtual private network, other types of networks, and/or a combination of the foregoing.

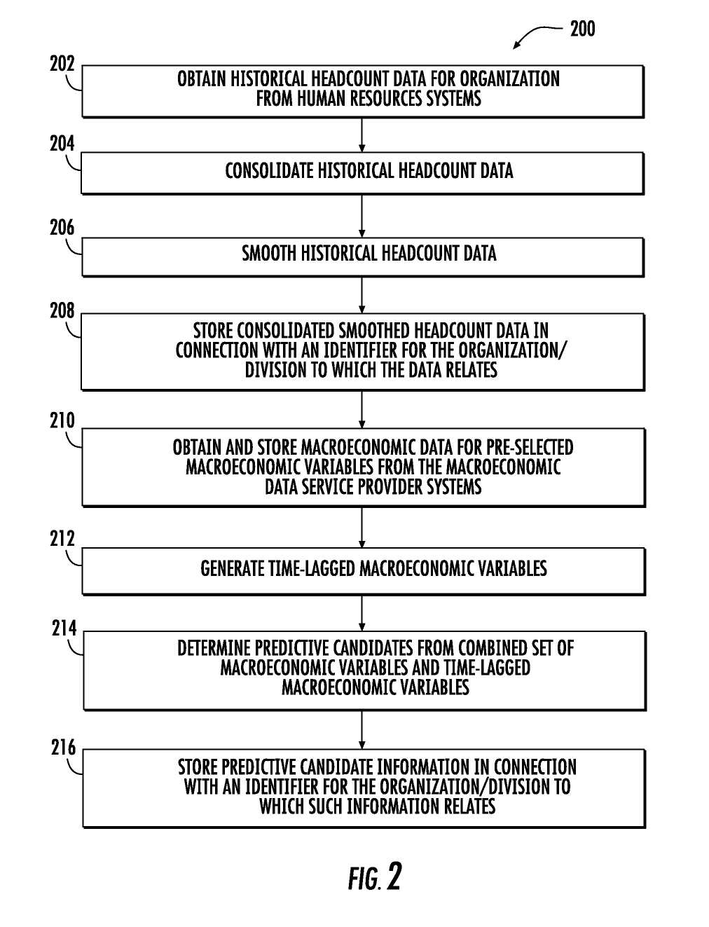

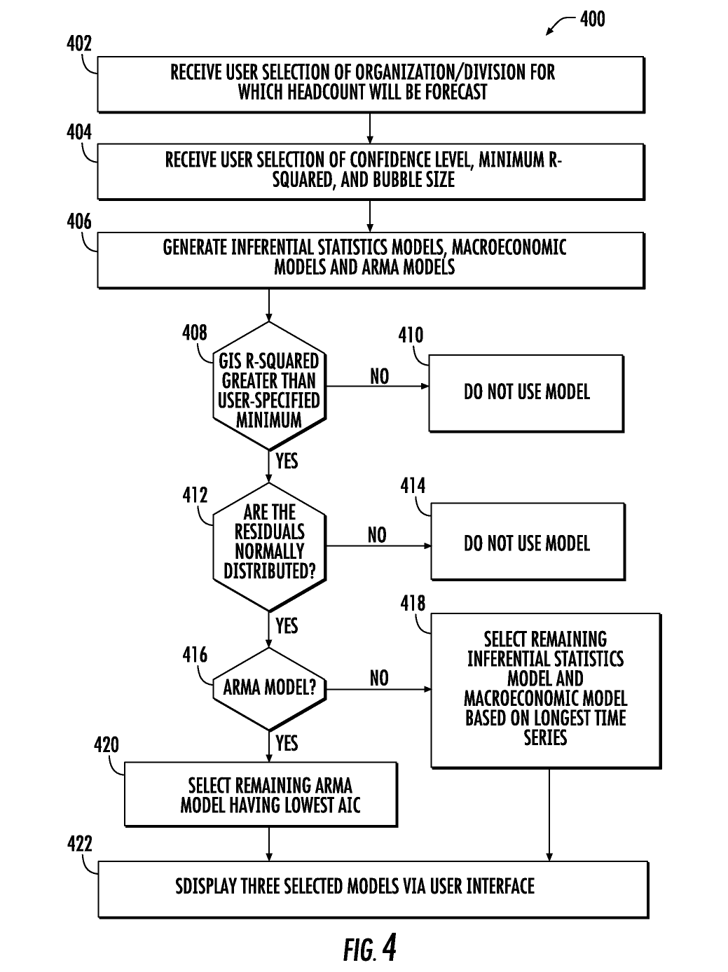

The processing apparatus 130 includes circuitry used for implementing communication and logic functions of the headcount forecasting system 110. For example, the processing apparatus 130 may include a digital signal processor device, a microprocessor device, and various analog-to-digital converters, digital-to-analog converters, and other support circuits. Control and signal processing functions of the headcount forecasting system 110 are allocated between these devices according to their respective capabilities. The processing apparatus 130 may include functionality to operate one or more software programs based on computer-readable instructions thereof, which may be stored in the memory apparatus 150. As described in greater detail below, in one embodiment of the invention, the memory apparatus 150 includes a data sourcing application 160, a data consolidating application 162, a stepwise analysis application 164 and a modeling application 166 stored therein for instructing the processing apparatus 140 to perform one or more operations of the procedures described herein and in reference to FIGS. 2 and 4. Some embodiments of the invention may include other computer programs stored in the memory apparatus 150.

In general, the memory apparatus 150 is communicatively coupled to the processing apparatus 130 and includes computer-readable storage medium for storing computer-readable program code and instructions, as well as datastores containing data and/or databases. More particularly, the memory apparatus 150 may include volatile memory, such as volatile Random Access Memory (RAM) including a cache area for the temporary storage of data. The memory apparatus 150 may also include non-volatile memory that can be embedded and/or may be removable. The non-volatile memory can, for example, comprise an EEPROM, flash memory, or the like. The memory apparatus 150 can store any of a number of pieces of information and data used by the headcount forecasting system 110 to implement the functions of the headcount forecasting system 110 described herein.

In the illustrated embodiment, the memory apparatus 150 includes datastores containing headcount data 152 and macroeconomic data 154. The headcount data 152 generally includes historical headcount information for an organization and/or division(s) thereof. In particular, the headcount data 152 may include multiple data sets, where each data set includes a headcount value, which is a measure of the number of people working for or assigned to the organization or particular division, and a time value, which is an indication of the date or time at which the measurement of headcount was taken. Each data set therefore can take the form of (t, HC), where t is the time and HC is the headcount at that time. For example, a particular organization may have had 130 employees as of Sep. 1, 2009 and 133 employees as of Oct. 1, 2009. This historical headcount information could be stored as part of the headcount data 152 within the memory apparatus 150 as two separate data sets, for example, (130, Sep. 1, 2009) and (133, Oct. 1, 2009). The time value does not have to be a particular date, and could be any indication of when the headcount measurement was taken, such as month and year, quarter of the year, etc.

According to different embodiments, the headcount data 152 may include the historic headcount information over a period of time for only one organization or one division thereof, for example, a particular organization or division that has been identified to be the subject of a headcount forecasting exercise, or the headcount data 152 may include the historic headcount information for multiple divisions within an organization (such as business group, geographic area, office building, etc.), the overall organization, and even multiple organizations. In the event the headcount data 152 includes data for multiple divisions and/or organizations, such headcount data 152 would be stored within the datastore such that all historical headcount information pertaining to one division or organization would be linked to or otherwise associated with an identifier for that particular division or organization. Thus, each data set within the headcount data 152 would be stored within the memory device 150 in connection with an identifier for the division and organization to which the data set relates. As discussed in greater detail below, storing historical data for multiple organizations and/or divisions in this manner advantageously allows a user of the headcount forecasting system 110 to forecast the headcount of any one of a number of organizations or divisions thereof in real time, as the modeling application 160 may retrieve the headcount data 152 pertaining to the particular organization or division utilizing the identifier associated with such organization or division. The headcount data 152 may be received from a user via the user interface 120. In a preferred embodiment, the headcount data 152 is obtained through electronic communication with another device, such as the human resources computer systems 170 of a subject organization, via the network 102 and utilizing the network interface 140, and then stored in the memory apparatus 150.

According to some embodiments, the macroeconomics data 154 generally includes both historical and forecasted economic indicators. For example, the macroeconomics data 154 may include information such as historical and forecasted interest rates (as imposed by various institutions), stock prices indices, median household income, household financial obligations ratio, unemployment rate, debt service burden, retail sales, crude oil price, etc. For each different indicator, there may be multiple data sets stored in the macroeconomics data 154 datastore of the memory apparatus 150 in the form (t, MEI), where t is the time and MEI is the value of the particular economic indicator (either actual or predicted, depending on the time value) at that time. Further, for each indicator, the macroeconomics data 154 may include both data sets having time values in the past and data sets having time values in the future. According to some embodiments, the data sets are organized within the memory apparatus 150 such that all of the data sets corresponding to a particular macroeconomic indicator will be stored in connection with an identifier associated with that macroeconomic indicator. The macroeconomics data 154 may be received from a user via the user interface 120, or, according to a preferred embodiment, may be obtained through electronic communication with another device, such as the macroeconomic data service provider computer systems 180, via the network 102 and utilizing the network interface 140, and then stored in the memory apparatus 150.

For the sake of clarity and ease of description, the figures provided herein generally illustrate the headcount data 152 as being stored in one datastore and the macroeconomics data 154 as being stored in a separate datastore. However, it will be understood that, in some embodiments, these datastores may be combined or the data described as being stored within such datastores may be further separated into additional datastores. For example, in some embodiments, the headcount data 152 may be split into different datastores based on the different divisions and/or organizations for which there is headcount data 152. Likewise, the macroeconomic data 154 may be split into different datastores based upon the different macroeconomic indicators for which there is historical and forecasted data.

As further illustrated by FIG. 1, the memory apparatus 150 also includes a data sourcing application 160, a data consolidating application 162, a stepwise analysis application 164, and a modeling application 166. As used herein, the term “application” generally refers to computer-readable program code comprising computer-readable instructions and stored on a computer-readable storage medium, where the instructions instruct a processor to perform certain functions, such as logic functions, read and write functions, and/or the like. In this regard, each of the data sourcing application 160, data consolidating application 162, stepwise analysis application 164, and modeling application 166 includes computer-readable instructions for instructing the processing apparatus 130 and/or other devices to perform one or more of the functions described herein, such as one or more of the functions described in FIGS. 2 and 4. While the data sourcing application 160, data consolidating application 162, stepwise analysis application 164, and modeling application 166 are drawn as separate applications within the memory apparatus 150, it should be understood that the functions of the four applications as described herein could be ascribed to any number of applications, including a single application or more than four applications.

FIG. 1 further provides the human resources computer systems 170 of a subject organization and one or more macroeconomic data service provider computer systems 180 in communication with the headcount forecasting system 110 via the network 102. In some embodiments, the human resources computer systems 170 include databases that house historical information about the organization's workforce, including historical headcount information. If the headcount forecasting system 110 is owned and operated by an organization that is seeking to forecast its own headcounts (whether overall or in a particular division), then the human resources computer systems 170 and the headcount forecasting system 110 may be in communication via the intranet of the organization. The macroeconomic data service provider computer systems 180 include databases housing historical and forecasted macroeconomic data. In some instances, the macroeconomic data service provider computer systems 180 are operated by one or more third party service providers and are configured to provide commercial products that supply economic data for download, including both historical and forecast, to consumers via the Internet. These products may be available on a subscription basis, offered for free, or otherwise provided online. In some embodiments, both the human resources computer systems 170 and the macroeconomic data service provider computer systems 180 supply data to be relied upon by the headcount forecasting system 110 in order to carry out the various processes described herein.

FIG. 2 provides a flow diagram illustrating a process 200 whereby the headcount forecasting system 110 of the present invention obtains, generates, stores and manages the headcount data 152 and macroeconomics data 154. As represented by block 202, according to some embodiments, the data sourcing application 160 instructs the processing apparatus 130 to operate the network interface 140 to communicate with the human resources computer systems 170 and retrieve historical headcount information for the organization. The headcount forecasting system 110 may be configured such that the data sourcing application 160 engages in communication with the human resources computer systems 170 on a periodic basis, and thus periodically obtains new headcount information to update the headcount data 152 in the memory apparatus 150. Alternatively, the data sourcing application 140 may establish a dynamic interface between the headcount forecasting system and the human resources computer systems 170 such that the headcount data 152 is automatically updated as soon as the headcount information in the databases of the human resources computer systems 170 is updated. In either instance, historical headcount information for an organization, including the headcount of the organization and, if applicable, divisions thereof, at various times in the past, is communicated by the human resources computer systems 170 to the headcount forecasting system 110, and the data sourcing application 160 instructs the processing apparatus 130 to store the received data, upon receipt by the headcount forecasting system 110, in the memory apparatus 150 as headcount data 152.

As represented by block 204, the headcount data 152 obtained from the human resources computer systems 170 may be consolidated by the data consolidating application 162. The data consolidating application 162 is configured to format and organize the raw headcount data 162 such that it can be readily utilized by the modeling application 166, as discussed in detail below. In some embodiments, the data consolidating application 162 is a relational database management program. For example, if the headcount forecasting system 110 is implemented in a Windows operating environment, the data consolidating application 162 may be Microsoft Access. The consolidating application 162 is configured to make any necessary adjustments to the data so that all of the headcount data 152 is broken into data sets of identical format, i.e. (t, HC). The consolidating application 162 is further configured to organize all of the headcount data 152 according to the particular division and organization to which it relates, for example, by assigning identifiers associated with the division and/or organization. Once the consolidating application 162 has performed the consolidating functions herein described on the headcount data 152, the headcount data 152 is structured such that, for each division and/or organization for which historical headcount information was obtained, there is a time series of headcount values, for example, HC₁), (t₂, HC₂), HC₃) and so on. Each of the data sets corresponds to a point on a graph having, for example, headcount on the y-axis and time on the x-axis. The time series will be utilized by the modeling application 166 to generate models and forecasts, and therefore, it is critical that the consolidating application 162 provide a time series in uniform and standardized format for each division/organization. The formatting and organizing functions of the data consolidating application 162 may be performed with or without instructions from a user via the user interface 120. The consolidated headcount data 152 is stored in the memory apparatus 150 to be accessed later by the modeling application 166.

According to block 206, the headcount data 152 may also be subjected to various smoothing processes wherein adjustments are made to enable the modeling application 166 to generate the headcount models, which models are described in detail below. The smoothing processes may be applied to the headcount data before a particular organization or division is identified by a user for headcount forecasting or, according to other embodiments, the smoothing processes may be applied once the modeling processes described herein with reference to FIG. 4 are initiated. In some embodiments, the data consolidating application 162 or the modeling application 166 instructs the processing apparatus to evaluate the headcount time series for each organization and division that is stored within the headcount data 152 of the memory apparatus 150 and apply one or more smoothing techniques to remove any apparent outlying data points (i.e. “outliers”) within the time series and account for any jumps in the time series, for example where the headcount suddenly increases at a particular time and remains at the higher value due to a merger or acquisition. The smoothing techniques employed could be any of the techniques known by those having skill in the art, including moving average smoothing, exponential smoothing, and/or running medians smoothing. For those instances where a merger or acquisition has upset the continuity of the time series, the smoothing method may be simply adding the amount of personnel acquired in the transaction to the data points in the time series prior to the transaction.

Thus, the raw headcount data obtained from the human resources systems 170 is consolidated and smoothed in order to obtain a final set of headcount data 152 for each organization and division for which raw data was received that is a smooth time series that may be subjected to the various modeling processes of the present invention. Once the smoothing techniques have been applied to the headcount data 152 for the various organizations and divisions (i.e. the various different headcount time series), as represented by block 208, the consolidated and smoothed headcount data 152 is stored in the memory apparatus 150 such that it can be accessed later by the modeling application 166. In some embodiments, each set of headcount data 152 relating to a particular organization and/or division is stored in the memory apparatus 152 in connection with one or more identifiers for such organization and/or division, such that the modeling application 166 can access the correct headcount data 152 using the identifier(s) upon a user requesting a forecast for the headcount of a particular organization or division via the user interface 120.

In one embodiment, one of the smoothing techniques employed by the headcount forecasting system 110 involves calculating the difference between each sequential headcount data point within a given time series (i.e. the time series for a particular division or organization) and identifying and replacing any outliers in the set of difference values with a smoothed difference value. Once a smoothed set of difference values is obtained, using the most recent headcount value within the original time series as a starting point, the smoothed set of difference values is used to generate a new time series. More specifically, the modeling application 166 or consolidating application 162 is configured to calculate, for each time series represented by (HC₁, HC₂, HC₃, . . . ), a set of difference values is calculated (HC₂−HC₁, HC₃−HC₂, . . . ). Any outliers in the set of difference values are smoothed, resulting in a smoothed set of difference values ((HC₂−HCᵢ)_{Smooth}, (HC₃−HC₂)_{Smooth}, . . . ). The most recent headcount value in the original time series, for example HC₁₀₀, will be used as the last value in the new smoothed time series. In order to generate the rest of the smoothed time series, the smoothed set of difference values will be used as follows: HC₉₉ will be generated by the calculation HC₉₉=HC₁₀₀−(HC₁₀₀−HC₉₉)_{Smooth} and HC₉₈ will equal HC₉₉−(HC₉₉−HC₉₈)_{Smooth}, and so on, until the entire headcount time series is generated using the smoothed set of difference values. This advantageously not only removes outliers but also advantageously ensures that the time series has the correct headcount value at the most recent time that it was measured.

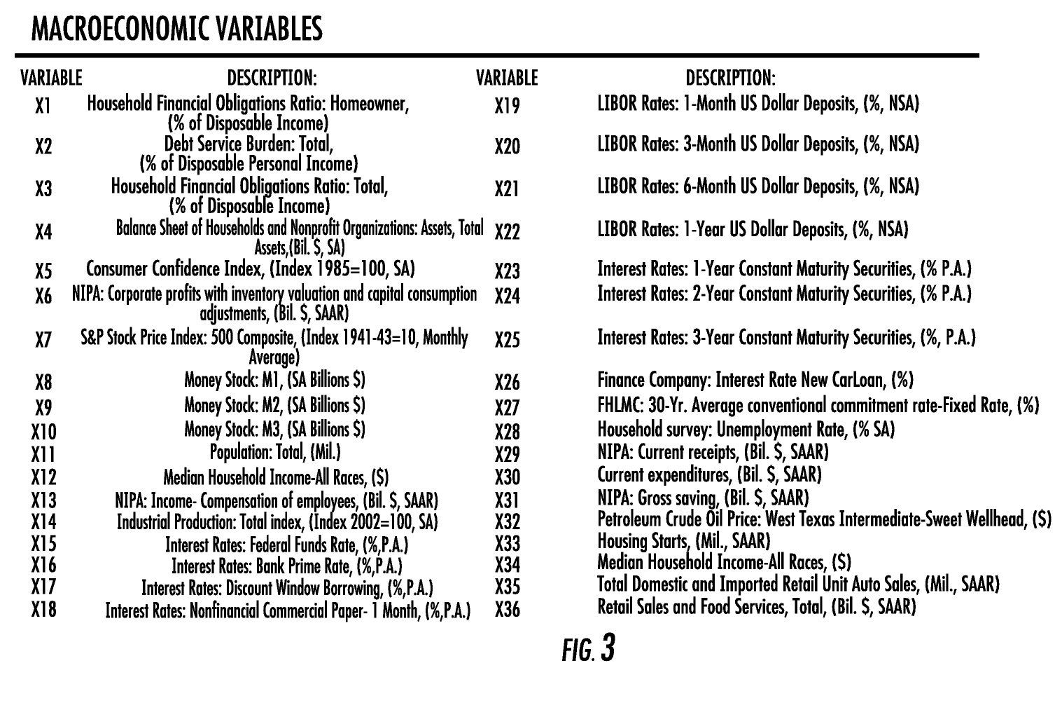

As represented by block 210, the macroeconomic data 154 is obtained from the macroeconomic data service provider systems 180. In particular, the data sourcing application 160 instructs the processing apparatus 130 to operate the network interface 140 to communicate with the macroeconomic data service provider systems 180 and obtain historical and forecasted values for a number of predetermined economic indicators and store the obtained data in the memory apparatus 150 as macroeconomic data 154. Because any of these indicators may be a variable in the equation for a macroeconomic model generated by the modeling application 166, as described in detail below, the indicators will be referred to herein as “variables.” Referring now to FIG. 3, in one embodiment, the headcount forecasting system 110 will obtain and store in the macroeconomic data 154 datastore historical and forecasted values for the thirty-six different variables shown in FIG. 3. Thus, for each of the thirty-six variables, there will be a time series, including both past and future time values, of the value of the variable. In some embodiments, the macroeconomic data service provider systems 180 are commercial products that provide economic information online, such as Moody's economy.com. The headcount forecasting system 110 may be configured to maintain an open interface with the macroeconomic data service provider systems 180 such that the headcount forecasting system 110 is continuously receiving updated values for the variables. Alternatively, the data sourcing application 160 may be configured to periodically reach out through the network interface 140 and obtain the updated macroeconomic data for the variables from the macroeconomic data service provider systems 180. In one embodiment, the data sourcing application 160 updates the macroeconomic data 154 in the memory apparatus 150 on a monthly basis after querying the macroeconomic data service provider systems 180 for updated values (both new historical values and new forecasted values) for the variables.

Next, as represented by block 212, the modeling application 166 instructs the processing apparatus 130 to access the stored macroeconomic data 154 in the memory apparatus 150 and generate new time-lagged macroeconomic variables. The purpose of generating time-lagged variables is to allow the headcount forecasting system 110 to capture any correlation between the variables and the headcount values that is subject to a lag between the time at which the variable had a particular value and the time at which the headcount had a particular value. Thus, while there may not be a strong correlation between the value of a particular variable, such as gross domestic product, at a specific time and the headcount of a division of an organization at that same time, there may be a very strong correlation between the value of the gross domestic product at a specific time and the headcount of the division four months later. In this example, the four-month time period is the lag. In some embodiments, in order to capture the lag and generate the time-lagged time series for each variable, the normal time series for the variable, as obtained from the macroeconomic data service provider systems 180, is adjusted by moving the data points forward in time by the amount of lag that is desired. This adjustment is performed by the processing apparatus 130 and the resulting time-lagged time series is stored in the memory apparatus 150 in accordance with instructions given by the modeling application 166. According to a preferred embodiment, each of the thirty-six variables shown in FIG. 3 is used to generate 12 new time-lagged variables having lags of 1 month to 12 months. Thus, following generation of the time-lagged variables, there are a total of 468 (36×13) variables that may be the basis for a correlation between the time series of such variables and the time series of headcount values and be used by the modeling application 166 to generate a macroeconomic model. This advantageously allows the modeling application 166 to pick from a variety of variables in order to obtain the best-fitting model for the headcount, as described in detail below.

As represented by block 214, the predictive variables for a particular headcount time series in the headcount data 152 are chosen using stepwise analysis. In particular, the stepwise analysis application 164 instructs the processing apparatus 130 to evaluate the headcount time series data 152 for a particular organization or division and the macroeconomic data 154 in the memory apparatus 150 and determine which of the 468 macroeconomic variables are predictive candidates for the purposes of generating a multivariable model for each smoothed headcount time series. A variable will be chosen as a predictive candidate only if there is an evident positive or negative correlation between the value of the macroeconomic variable (which may be a time-lagged variable) at a particular time and the headcount at the same time (in the case of the time-lagged variables, the correlation actually exists at different times). The stepwise analysis application 164 that locates the correlations may be a commercial software product, such as JMP, and may utilize forward selection, i.e. starting with none of the macroeconomic variables chosen to be predictive variables for the model, and trying out the variables one by one and including them if they are determined to be statistically significant, or backward elimination, i.e. starting with all macroeconomic variables as predictive candidates, testing them one by one for statistical significance, and deleting any that are not significant, or a combination of forward selection and backward elimination.

Once the predictive candidates have been chosen, as represented by block 216, the choices of variables are recorded in the memory apparatus 150 in connection with an identifier of the particular organization or division in connection with which the variables were chosen. The divisions of the organization may include building unit, line of business, geographic area, etc. Each division will have its own distinct time series of headcount data for the division and may also have different predictive candidates from the macroeconomic variables that are selected by the stepwise analysis application 164. Inasmuch as stepwise analysis is a time-consuming process, according to one embodiment of the present invention, the stepwise analysis is performed for the different lines of business within the organization but not for smaller divisions of the organization, such as building unit. Thus, each line of business (for example, in a financial institution, lines of business may include card services, residential mortgage, consumer banking, etc.) may have different predictive candidates selected from the macroeconomic variables by the stepwise analysis application 164. These predictive candidates will be used by the modeling application 166 whenever a headcount forecast is requested that pertains to a specific line of business, even if the headcount request is limited to a particular building unit. Furthermore, the stepwise analysis performed by the stepwise analysis application 164 may be performed on a periodic basis to ensure that the chosen predictive variables for each line of business are still accurate, i.e. statistically significant. For example, in one embodiment, the stepwise analysis application 164 is run every six months and the predictive candidates for each line of business are updated in the memory apparatus 150.

Referring now to FIG. 4, a flow chart is provided that illustrates a process 400 whereby the headcount forecasting system 110 of the present invention generates three unique models of the headcount of a particular organization or division thereof over time, including an inferential statistics model, a macroeconomic model, and an autoregressive moving average (“ARMA”) model, and displays such models to a user via the user interface 120. As represented by block 402, a user of the headcount forecasting system 110 first selects the particular organization and/or division of an organization for which it desires a headcount forecast. In some embodiments, the modeling application 166 instructs the processing apparatus 130 to present to the user for selection via the user interface 120 all of the organizations and divisions (including line of business, geographic area, building unit, etc.) for which headcount data 152 is stored in the memory apparatus 150. Using the user interface 120, the user makes a selection of a particular organization or division from the options presented, and the processing apparatus 130 receives such selection. For example, the selection may be a particular line of business within the organization, but limited to a particular geographic region. Thus, the user has indicated a desire to obtain a headcount forecast for that line of business in that geographic region.

As represented by block 404, the user may further enter additional information for use by the modeling application 166 in rendering the models of the present invention. In particular, the user may, via the user interface 120, enter a desired confidence level, a desired minimum coefficient of determination, i.e. “R-squared,” and a desired bubble size. The confidence level entered by the user will be utilized by the modeling application 166 to generate a confidence interval for the forecasted headcount. The confidence level may be chosen between 0% and 100%, where the percentage value indicates how likely it is that the future headcount will fall within the resulting confidence interval. Thus, increasing the desired confidence level will widen the confidence interval and decreasing the desired confidence level will reduce the width of the confidence interval. In the event a particular user would like to see a confidence interval that has a 95% likelihood of containing the future headcount of the organization or division, then the user will select 95% as the input confidence level. In some embodiments, the default confidence level is 95%.

As generally used in statistical modeling, the R-squared value is the proportion of variability in a data set that is accounted for by the statistical model. It provides a measure of how well future outcomes are likely to be predicted by the model. Thus, in the context of the present invention, the R-squared value indicates how much of the variation in the headcount time series is explained by the model. An R-squared of 0.95, or 95%, would indicate that 95% of the variation is explained by the model. On the other hand, an R-squared of 0.1, or 10%, would indicate that only 10% of the variation is explained by the model. The closer the R-squared is to 1 or 100%, the better the fit of the model. In some embodiments, the headcount forecasting system 110 requires that the R-squared value of a particular model be at least 50% in order to display such model to the user, but it will permit the user to set the minimum R-squared value even higher to demand better results. In some embodiments, the default R-squared value is 75%.

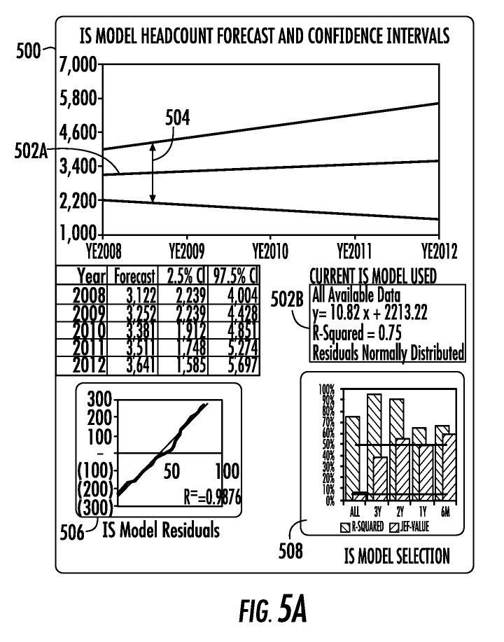

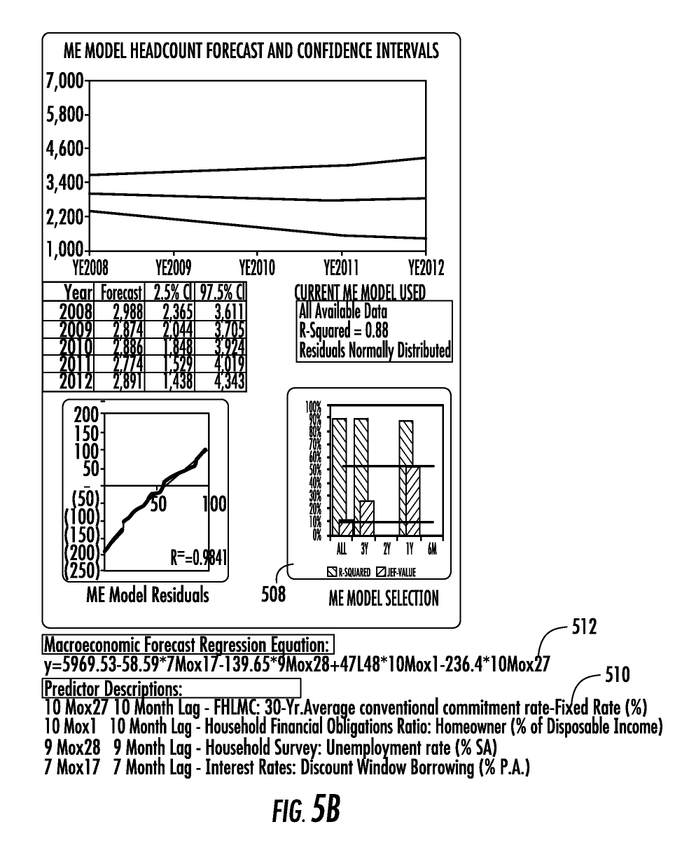

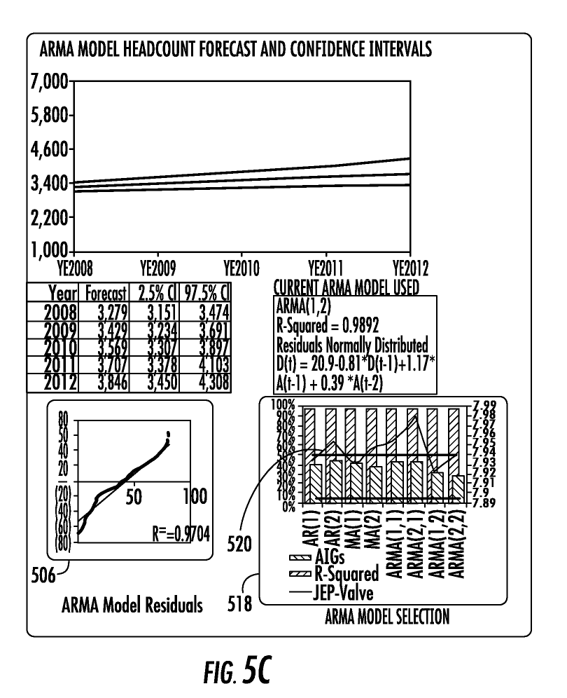

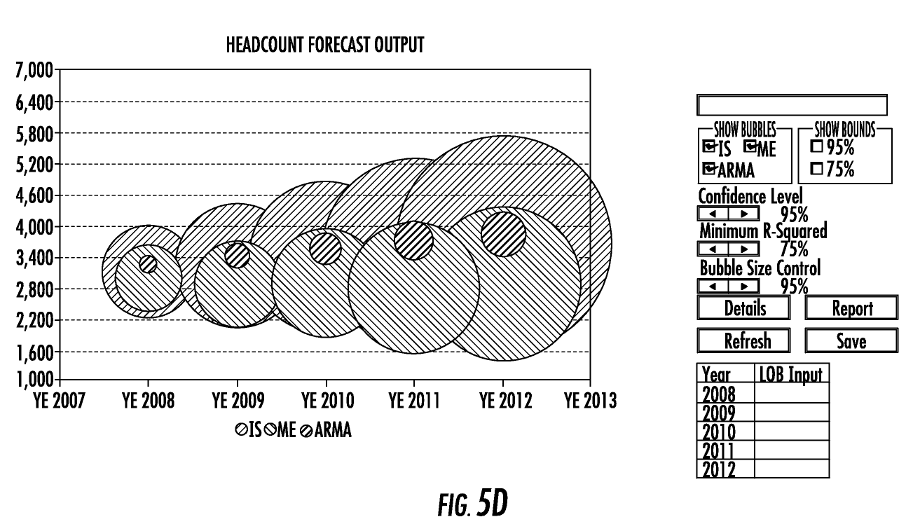

Finally, the bubble size entered by the user may also take the form of a percentage from 0% to 100%. The bubble size percentage is similar to the confidence level in that the percentage value of the bubble size indicates the likelihood that the future headcount will fall within a particular bubble displayed by the modeling application 166 via the user interface 120. Unlike the confidence interval generated by the confidence level, however, the bubbles generated by the bubble size percentage are set at distinct time values in the future. Thus, while the confidence interval will show the interval for each and every time value in the future, the bubbles will appear only at certain points in the model, for example at each of the forecasted headcount at years 1 through 5 in the future. In some embodiments, the default bubble size is the same as the confidence level, i.e. 75%. The displays associated with the confidence intervals and bubbles will be discussed in further detail below with reference to FIGS. 5A through 5D.

Referring again to FIG. 4, as represented by block 406, once the user has made its selection of organization/division and confidence level, minimum R-squared, and bubble size, the modeling application 166 instructs the processing apparatus 130 to render the models. According to some embodiments, the processing apparatus 130, according to instructions from the modeling application 166 will render at least one single-variable linear inferential statistics model, at least one multivariable macroeconomic model, and at least one ARMA model. In order to render the models, the modeling application 166 will access the historical headcount data 152 and macroeconomic data 154 stored in the memory apparatus 150, as well as the predictive candidate information for the line of business as determined by the stepwise analysis application 164. Using the organization/division selection previously made by the user, the modeling application 166 instructs the processing apparatus 130 to query the headcount data 152 in the memory apparatus 150 and retrieve the headcount time series associated with the identifier(s) for that particular organization/division. In the event that the retrieved time series in the headcount data 152 has not previously been smoothed, the modeling application may perform one or more smoothing techniques (as discussed in detail above) to generate a smoothed headcount time series for the organization/division that can be used as the basis for rendering the various models. Furthermore, the modeling application 166 will also instruct the processing apparatus 130 to query the memory apparatus 150 to determine which macroeconomic variables are the predictive candidates that should be utilized to render the macroeconomic model and, upon making such a determination, retrieve the macroeconomic data 154 for such variables.

The modeling application 166 employs methods known in the art to render each of the inferential statistics models, macroeconomic models, and ARMA models using the time series headcount data 152 associated with the organization/division selected by the user via the user interface 120 and, in the case of the macroeconomic models, the macroeconomic data 154 associated with the particular macroeconomic variables identified as predictive candidates according to the stepwise analysis application 164. According to one embodiment, the modeling application 166 renders five different inferential statistics models, five different macroeconomic models, and eight different ARMA models.

The inferential statistics models generated by the modeling application 166 are simple linear regression models with headcount as the dependent variable and time as the independent variable. In some embodiments, the modeling application 166 is configured to generate different inferential statistics models for a particular organization or division by utilizing different portions of the time series headcount data 152 for that organization or division that is stored in the memory apparatus 150. For example, the modeling application 166 may generate one inferential statistics model using the historical headcount data 152 for the organization/division corresponding to the past six months only, another inferential statistics model using the historical headcount data 152 for the past year, another using the historical headcount data 152 for the past three years. Thus, the modeling application 166 may select different time series within the overall headcount time series for the particular organization/division and obtain different inferential statistics models therefrom. In one embodiment where the historical headcount data 152 dates back at least three years, the modeling application 166 is configured to generate five different inferential statistics models, including one model based on the entire headcount time series, and four models based on portions of the headcount time series dating back six months, one year, two years, and three years. As discussed further below, rendering multiple models using different portions of the time series advantageously allows the modeling application 166 to obtain the model having the best fit to the headcount data in order to provide the user with the most accurate forecast.

The macroeconomic models generated by the modeling application 166 are multivariate regression models where the macroeconomic variables (including time-lagged variables) that were selected as predictive candidates for the organization/division through the stepwise analysis procedure are the independent variables and headcount of the organization/division is the dependent variable. The modeling application uses the historical headcount data 152 stored in the memory apparatus 150 as well as the historical and predicted macroeconomic data 154 previously obtained from the macroeconomic data service provider systems 180 and stored in the memory apparatus 150 in order to determine the correct coefficients for the macroeconomic variables and render the model. Just as with the inferential statistics model, in some embodiments, the modeling application 166 is configured to render multiple macroeconomic models by using different portions of the overall headcount time series for the organization or division. For example, in one embodiment where the historical headcount data 152 dates back at least three years, the modeling application 166 is configured to generate five different macroeconomic models, including one model based on the entire headcount time series, and four models based on portions of the entire headcount time series dating back six months, one year, two years, and three years.

With respect to the ARMA models rendered by the present invention, an ARMA model is generally a univariate time series model that is based on the notion that all past events are represented in the current data point. The ARMA model consists of two parts, an autoregressive (AR) part and a moving average (MA) part. The model may then be referred to as the ARMA(p,q) model where p is the order of the autoregressive part and q is the order of the moving average part. In one embodiment, the modeling application 166 generates eight distinct ARMA models using different p and q values. For example, the eight ARMA models may include ARMA(1,0) (which is the equivalent of simple AR(1)), ARMA(0,1), ARMA(2,0), ARMA(0,2), ARMA(1,1), ARMA(1,2), ARMA (2,1), and ARMA(2,2). Thus, unlike with the inferential statistics models and the macroeconomic models, according to some embodiments, the modeling application 166 does not render different models by segmenting the headcount time series into different time periods going backwards from the present, but rather generates different models by altering the p and q values to account for different lags.

Once the inferential statistics, macroeconomic, and ARMA models are generated by the modeling application 166, the modeling application 166 is further configured to evaluate and validate the rendered models. According to some embodiments and as represented by block 408, for each model generated by the modeling application 166, the modeling application 166 calculates the R-squared value using methods known in the art and compares that value to the default R-squared minimum or the R-squared minimum set by the user, if any. In the event the R-squared of any model generated by the modeling application 166 does not meet or exceed the minimum R-squared, then, as represented by block 410, that model is discarded and will not be used as a headcount forecasting model that will be displayed to the user.

As represented by block 412, a second method of evaluating and validating the models generated by the modeling application 166 involves determining whether, for each model, the model residuals are normally distributed. Model residuals are elements of variation that are unexplained by the model. Since this is a form of error, in order to have an efficient model, the residuals should be normal and independently distributed with a mean of zero. In some embodiments, the modeling application 166 employs the Jacque-Berra (“JB”) goodness of fit test in order to determine if the residuals are normally distributed, which test involves calculating a certain value, known as the p-value, and determining whether it is greater than a pre-defined alpha value, generally having a default value of 0.05. Other known methods may be employed in the alternative. Thus according to some embodiments, the modeling application 166 is configured to utilize the JB test to determine whether the residuals are normally distributed, and, if the residuals for any model are not normally distributed, as represented by block 414, the modeling application 166 will discard such model and it will not be used to forecast headcount or otherwise be displayed to the user.

The modeling application 166 is further configured to select one of each of the remaining inferential statistics models, macroeconomic models, and ARMA models. In the event that all of one type of model were eliminated due to inadequate R-squared values or failure to have normally-distributed residuals, then there will be no selection made for that type of model. As shown in block 416, according to some embodiments, the modeling application 166 may first determine whether a particular model is an ARMA model prior to selecting the final model to be displayed to the user because different criteria will be used to select the best ARMA model from the criteria used to select the best inferential statistics and macroeconomic models. As represented by block 418, the modeling application 166 will select one inferential statistics model and one macroeconomic model to be displayed to the user. Only those models that have passed through the tests for minimum R-squared and normally-distributed residuals will be candidates for selection. In some embodiments, the modeling application 166 will make its selection based on which model was rendered using the longest time series. For example, if two different macroeconomics models remain in contention and one was based on headcount data for the past six months and the other was based on headcount data for the past two years, the latter model will be selected by the modeling application 166. This selection methodology relies on the assumption that the larger the sample of data used to generate the model, the more accurate the model will be. Indeed, in some embodiments, the modeling application 166 may have another independent test (in addition to the tests involving minimum R-squared and normally-distributed residuals) that concerns whether the sample size (i.e. the number of data points in the headcount time series) is sufficient. Because headcount is a discrete count, the modeling application 166 must rely on the binomial distribution approximation of the normal distribution in order to use some regression techniques. Thus, the modeling application 166 may employ known methods and test to determine whether the binomial distribution is sufficiently approximate to the normal distribution such that the associated estimation techniques are valid, and may discard any models that fail to pass such tests.

For the ARMA models, as represented by block 420 and according to one embodiment, the modeling application 166 utilizes Akaike's information criterion (“AIC”), a known tool for model selection that measures and compares the goodness of fit of multiple models. Thus, the modeling application 166 will calculate the AIC of the remaining ARMA models (after any have been discarded for failing other tests) and will rank them according to their AIC, finally selecting the one model having the lowest AIC. It should be understood that the methods described herein for selecting a single best model from each of multiple inferential statistics models, multiple macroeconomic models, and multiple ARMA models are not exclusive, and the selection may be made according to other methods known in the art. Once all three models have been selected, as represented by block 422, the modeling application 166 instructs the processing apparatus 130 to utilize the user interface 120 to display all three models to the user in graphical format. Some of the various displays that may be presented to the user via the user interface 120 will now be discussed in further detail with reference to FIG. 5.

FIG. 5A provides an exemplary user interface display of an inferential statistics model generated and selected in accordance with embodiments of the present invention. A graph 500 is provided having time on the x-axis and headcount on the y-axis, with the model represented thereon in graphical format as line 502A, with the equation for the model provided at 502B. The confidence level chosen in this instance was 97.5 percent, and results in the confidence interval 504 displayed on the graph 500. A residuals graph 506 is further provided, illustrating the distribution of the model residuals. Finally, a bar graph 508 is provided that demonstrates how each of the different inferential models generated by the modeling application (i.e. models for time series of 6 months, 1 year, 2 years, 3 years, and the entire time series) performed in terms of the two applicable tests: meeting the minimum R-squared and having normally-distributed residuals. As evident from the bar graph 508, each time series model met the R-squared requirement (set at 50%) and at least two of the models met the requirement that residuals be normally distributed, i.e. have a JB p-value over 0.05. Thus, since multiple models passed the two tests, the modeling application 166 is configured to select the model corresponding to the longest headcount time series, which in this case is the model based on the entire time series. That is the model represented by line 502A and equation 502B and displayed on graph 500.

Similar to FIG. 5A, FIG. 5B illustrates an exemplary user interface display of a macroeconomic model generated and selected in accordance with embodiments of the present invention and FIG. 5C illustrates an exemplary user interface display of an ARMA model selected in accordance with embodiments of the present invention. With reference to FIG. 5B, the macroeconomic variables selected as predictive candidates 510 are presented and described. Furthermore, the equation 512 for the model using the predictive candidates 510 is also presented. With reference to FIG. 5C, it is shown that the model selection bar graph 518 is different from those provided with respect to the inferential statistics models and macroeconomic models. In particular, the model selection bar graph 518 provides an evaluation using AIC, as described in detail above. In particular, line 520 depicts the various AIC values across the different ARMA models rendered by the modeling application 166. As shown, the model corresponding to ARMA(1,2) had the lowest AIC value, and thus it was selected by the modeling application 166 as the model to be displayed to the user in the main graph.

Finally FIG. 5D provides an illustration of an exemplary user interface display of all three models presented in bubble format in combination on the same graph. At each forecasted year, there is provided a bubble for each of the selected inferential statistics, macroeconomic, and ARMA model. The center of each bubble corresponds to the actual forecasted headcount based on the particular model, while the outer limits of each bubble represents the confidence interval. Thus, it is an object of the present invention that users of the headcount forecasting system 110 will be provided with an opportunity to review the best model from each of the different categories of models (inferential statistics, macroeconomic, and ARMA) and compare the results in graphical format. In the event the user, upon viewing the results, wishes to change the minimum R-squared value or the confidence level or bubble size, the user may do so and the output will be adjusted in real-time. Thus, the headcount forecasting system 110 provides real-time accurate modeling for corporate planners and others interested in obtaining on-demand headcount forecasts for an organization or particular division thereof.

It should be understood that FIGS. 5A through 5D are merely exemplary user interface outputs of the headcount forecasting system 110 and a user of the headcount forecasting system 110 may view other outputs via the user interface 120. For example, the models may not be displayed in graphical format, but as a chart or spreadsheet. Furthermore, the headcount forecasting system 110 may be configured to receive from a user via the user interface 120 the input of a particular future date or time at which the headcount should be estimated. In such an instance, the headcount forecasting system 110 may display to the user three distinct values for the headcount at that date or time, where the different values correspond to the different forecast headcount according to the inferential statistics, macroeconomic, and ARMA models. In other embodiments, the user may be able to customize the time period for which the various models are displayed on the graph. Those having skill in the art will appreciate that there are a multitude of ways in which the data (i.e. forecasted headcount values) generated by the three models may be conveyed to the user via the user interface 120.

The headcount forecasting system 110 of the present invention may be utilized by a user in numerous ways to estimate future headcounts of an organization. For example, a user such as a corporate planner may wish to obtain an estimate of the headcount of a particular division of the corporation in three years. In such a case, according to some embodiments, the user would identify the division and input the desired R-squared, confidence level, and bubble size via the user interface 120. In response, the headcount forecasting system 110 would initialize the modeling application 166 which would utilize the various datastores in the memory apparatus 150, including the headcount data 152, macroeconomic data 154, and predictive candidate data, and render the inferential statistics, macroeconomic and ARMA models. Next the headcount forecasting system would automatically choose the best model in each category for presentation to the user, which may be accomplished using the methodology described herein, and present the forecasted headcount values generated by the three models to the user in some manner, including those presented in FIGS. 5A through 5D. The corporate planner may then review the three distinct outputs of forecasted headcount values at year three of the model, whether represented on a graph, in a spreadsheet, or output directly in response to the user inputting a request for the values at year three. Furthermore, the corporate planner can review the different bubbles and confidence intervals associated with the three models at year three.

The corporate planner can use the forecasted headcount values, confidence intervals, and bubble sizes to determine the value that should be used for planning purposes. While one corporate planner may decide to use the value provided by the ARMA model, another may decide to use an average of the three values provided by all three models. While one planner may use the lowest forecasted headcount value, another may use the highest, and so on. In any case, the large amount of data provided by the headcount forecasting system 110, i.e. three different models and different confidence intervals, allows the planners to have a broader understanding of the forecasts and the forecasting process and to understand that there are different estimates, each of which may be off by as shown by the confidence intervals and bubbles. This is a highly advantageous feature of the present invention in that it allows the planners to interpret the output data and determine their own particular forecast value according to their specific needs. Current methods generally generate a single value and do not enable planners to have this flexibility in interpretation. Thus, the headcount forecasting system 110 of the present invention is a unique tool that provides planners with a comprehensive, real-time approach to headcount forecasting that is a significant advantage over known systems.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for forecasting the future headcount of a group of individuals comprising:
a user interface;
a memory device comprising computer-readable program code, historical headcount data for the group and macroeconomic data; and
a processor operatively coupled to the user interface and the memory device and configured to execute the computer-readable program code to:
receive, via the user interface, a request for a forecast of the future headcount of the group of individuals;
locate in the memory device, in response to the request, the historical headcount data for the group and the macroeconomic data;
utilize the historical headcount data to generate at least one linear regression model and at least one autoregressive moving average model;
utilize the historical headcount data and the macroeconomic data to generate at least one multivariate macroeconomic model; and
display one of the at least one linear regression models, one of the at least one autoregressive moving average models, and one of the at least one multivariate macroeconomic models via the user interface.

2. The system of claim 1, wherein the processor is configured to display one of the at least one linear regression models, one of the at least one autoregressive moving average models, and one of the at least one multivariate macroeconomic models in combination on a graph having time on the x-axis and headcount on the y-axis.

3. The system of claim 1, further comprising a network interface, wherein the processor is configured to further execute the computer-readable program code to:
obtain at least a portion of the historical headcount data via the network interface from a database comprising information about the individuals.

4. The system of claim 1, further comprising a network interface, wherein the processor is configured to further execute the computer-readable program code to:
obtain at least a portion of the macroeconomic data via the network interface from an online service provider.

5. The system of claim 1, wherein the historical headcount data comprises a time series of the headcount of the group over a period of time prior to utilization of the system.

6. The system of claim 1, wherein the macroeconomic data comprises historical and forecasted values for a plurality of macroeconomic variables.

7. The system of claim 6, wherein the processor is configured to further execute the computer-readable program code to:
generate at least one time-lagged variable for each macroeconomic variable in the plurality of macroeconomic variables.

8. The system of claim 7, wherein the processor is configured to further execute the computer-readable program code to:
perform a stepwise analysis using the historical headcount data and the macroeconomic data to determine which of the plurality of macroeconomic variables and the time-lagged variables are correlated with the historical headcount data.

9. The system of claim 8, wherein the at least one macroeconomic model is generated using the macroeconomic variables and time-lagged variables that are correlated with the historical headcount data as the sole independent variables.

10. The system of claim 1, wherein the processor is further configured to execute the computer-readable program code to:
smooth the historical headcount data.

11. The system of claim 1, wherein the processor is further configured to execute the computer-readable program code to:
receive, via the user interface, a selection of minimum R-squared value and confidence level.

12. The system of claim 1, wherein the processor is further configured to execute the computer-readable program code to:
receive, via the user interface, a selection of bubble size.

13. The system of claim 1, wherein the system is configured to only display models that meet a minimum R-squared value and have normally-distributed residuals.

14. The system of claim 1, wherein the system is configured to forecast the future headcount of more than one group of individuals.

15. The system of claim 14, wherein the historical headcount data comprises headcount time series related to multiple groups, and wherein each headcount time series is stored in connection with an identifier associated with the group of individuals to which the headcount time series relates.

16. The system of claim 15, wherein the headcount time series is located in the memory device in response to the request by utilizing the identifier.

17. The system of claim 1, wherein the processor is further configured to execute the computer-readable program code to:
disqualify for display any model rendered by the system that does not have an R-squared value that meets or exceeds a predefined minimum; and
disqualify for display any model rendered by the system that does not have normally-distributed residuals.

18. The system of claim 17, wherein the processor is further configured to execute the computer-readable program code to:
select the one linear regression model for display from any linear regression models not previously disqualified based on the number of data points in the time series used to render it;
select the one multivariate macroeconomic model for display from any multivariate macroeconomic models not previously disqualified based on the number of data points in the time series used to render it; and
select the one autoregressive moving average model for display from any autoregressive moving average models not previously disqualified based on an Akaike information criterion analysis.

19. A method for forecasting the future headcount of a group of individuals comprising:
storing historical headcount data for the group of individuals;
identifying macroeconomic variables that are correlated to the historical headcount data;
storing historical and forecasted macroeconomic data for the identified macroeconomic variables;
generating at least one linear regression model and at least one autoregressive moving average model utilizing the stored historical headcount data;
generating at least one multivariate macroeconomic model utilizing the stored historical headcount data and the stored macroeconomic data; and
presenting one of the at least one linear regression models, one of the at least one autoregressive moving average models, and one of the at least one multivariate macroeconomic models in combination.

20. The method of claim 19, wherein at least a portion of the historical headcount data was obtained via a network from a database comprising human resources information relating to the individuals.

21. The method of claim 19, wherein at least a portion of the macroeconomic data was obtained via a network from an online service provider.

22. The method of claim 19, wherein the historical headcount data comprises one or more headcount time series.

23. The method of claim 19, wherein the macroeconomic variables are identified utilizing a stepwise analysis process.

24. The method of claim 19, wherein the macroeconomic variables comprise time-lagged variables.

25. The method of claim 19, further comprising:
receiving a request from a user for a headcount forecast.

26. The method of claim 19, further comprising:
receiving a selection of minimum R-squared value and confidence level.

27. The method of claim 19, further comprising:
smoothing the historical headcount data to remove any outliers.

28. The method of claim 19, wherein a plurality of linear regression models are generated, a plurality of multivariate macroeconomic models are generated, and a plurality of autoregressive moving average models are generated.

29. The method of claim 28, wherein:
each linear regression model in the plurality of linear regression models was generated using a different portion of the historical headcount data;
each multivariate macroeconomic model in the plurality of multivariate macroeconomic models was generated using a different portion of the historical headcount data; and
each autoregressive moving average model in the plurality of autoregressive moving average models has either a different autoregressive order or a different moving average order.

30. The method of claim 29, further comprising:
disqualifying for display any model generated that does not have an R-squared value that meets or exceeds a predefined minimum; and
disqualifying for display any model generated that does not have normally-distributed residuals.

31. The method of claim 30, wherein:
the one linear regression model displayed is selected from any linear regression models not previously disqualified based on the length of the time series used to render it;
the one multivariate macroeconomic model displayed is selected from any multivariate macroeconomic models not previously disqualified based on the length of the time series used to render it; and
the one autoregressive moving average model displayed is selected from any autoregressive moving average models not previously disqualified based on an Akaike information criterion analysis.

32. A computer program product for forecasting the future headcount of a group of individuals comprising a computer-readable medium having computer-readable program code stored therein, wherein the computer-readable program code comprises:
a first code portion configured to obtain via a first network historical headcount data for the group of individuals;
a second code portion configured to identify macroeconomic variables that are correlated to the historical headcount data;
a third code portion configured to obtain historical and forecasted macroeconomic data corresponding to the identified macroeconomic variables;
a fourth code portion configured to generate at least one linear regression model and at least one autoregressive moving average model utilizing the stored historical headcount data; and
a fifth code portion configured to generate at least one multivariate macroeconomic model utilizing the historical headcount data and the macroeconomic data.

33. The computer program product of claim 32, further comprising:
a sixth code portion configured to display via a user interface one of the at least one linear regression models, one of the at least one autoregressive moving average models, and one of the at least one multivariate macroeconomic models in combination.

34. The computer program product of claim 32, further comprising:
a seventh code portion configured to receive a time value via a user interface;
an eighth code portion configured to input the time value into the at least one linear regression model, the at least one autoregressive moving average model, and the at least one multivariate macroeconomic model to calculate three headcount values corresponding to the time value; and
a ninth code portion configured to display the three headcount values via the user interface.
